(19) United States
(12) Patent Application Publication
(10) Pub. No.: US 2009/0204401 A1
(43) Pub. Date: Aug. 13, 2009

(54) SPEECH PROCESSING SYSTEM, SPEECH PROCESSING METHOD, AND SPEECH PROCESSING PROGRAM

(75) Inventor: Shehui Bu, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/270,176

(22) Filed: Nov. 13, 2008

(30) Foreign Application Priority Data
Feb. 7, 2008 (JP) 2008-27745

(51) Int. Cl. G10L 13/08; G10L 13/00; G10L 21/00

(52) U.S. Cl. 704/260; 704/277; 704/4; 704/E15.043; 704/E15.02

(57) ABSTRACT

Provided is a speech translation system for receiving an input of the original speech in a first language, translating an input content into a second language, and outputting a result of the translating as a speech, including: an input processing part for receiving the input of the original speech, and generating, from the original speech, an original language text and the prosodic information of the original speech; a translation part for generating a translated sentence by translating the first language into the second language; prosodic feature transform information including associated prosodic information between the first language and the second language; a prosodic feature transform part for transforming the prosodic information of the original speech into prosodic information of the speech to be output; and a speech synthesis part for outputting the translated sentence as a speech synthesized based on the prosodic information of the speech to be output.

### CLAIM OF PRIORITY

The present application claims priority from Japanese application JP2008-27745 filed on Feb. 7, 2008, the content of which is hereby incorporated by reference into this application.

### BACKGROUND OF THE INVENTION

This invention relates to a technology for transforming speech data input in an original language into speech data in a target language, and outputting the speech data transformed into the target language as a speech.

As international exchanges have recently become active, necessity for multi-lingual communication has increased, and multi-lingual interpreters are thus required for the multi-lingual communication. As means for realizing the multi-lingual communication, due to increased processing capabilities of computers and utilization of high-capacity databases, the speech recognition technology and the natural language processing technology, especially speed and accuracy of the machine translation technology intended for texts, have progressed. Moreover, the quality of the speech synthesis technologies has increased, and a multi-lingual speech translation device employing these technologies has become practical as disclosed in, for example, JP 2005-141759 A.

In a speech translation device, in order to increase the accuracy of translation, based on important word rule extraction conditions, important portions in input original language information are determined, and, based on a result of the determination, it is possible to set a translation accuracy. Moreover, based on the set accuracy, a technology for translating original language information into translated language information described in a target language is disclosed in, for example, JP 2004-355118 A.

Further, in a speech translation system, in order to increase a speech quality, a technology for extracting speech features of a speaker from an input speech in an original language, measuring similarity to a speech in a target language, and, based on an obtained result of similarity in speech features, synthesizing the speech in the target language relatively similar to speech features of the speech in the original language is disclosed in, for example, JP 2006-330298 A.

### SUMMARY OF THE INVENTION

The above-mentioned conventional technologies are realized by measuring the speech features of the input speech in the original language, and controlling a speech synthesis part for the target language. Moreover, the translation to the target language is carried out based on a result of determination of the importance of the input original language. However, according to the conventional speech translation systems, since there is no technology for automatically transforming prosodic features of a speech, and difference information between prosodic feature patterns of input and output speeches and standard prosodic feature patterns is not used, it is not possible to achieve a sufficient accuracy.

It is therefore an object of this invention to provide a speech translation system for outputting, by using prosodic features of an input speech in an original language, a speech in a target language in a more natural and more accurate manner.

The representative aspects of this invention are as follows. That is, there is provided a speech processing system for receiving an input of an original speech in a first language, transforming a content of the input into a second language, and outputting a result of the transforming as a speech. A speech processing system includes: an input processing part for receiving the input of the original speech, and generating, from the original speech, an original language text, which is a text in the first language, and prosodic information of the original speech; a translation part for generating a translated sentence which is obtained by transforming the original language text from the first language into the second language; prosodic feature transform information including a correspondence relationship between prosodic information of the first language and prosodic information of the second language; a prosodic feature transform part for transforming, based on the prosodic feature transform information, prosodic information of the original speech into prosodic information of the speech to be output; and a speech synthesis part for outputting the translated sentence as a speech synthesized based on the prosodic information of the speech to be output.

According to the aspect of this invention, it is possible to output, based on the prosodic information of the input speech in the first language (original language), a speech in the second language (target language).

### BRIEF DESCRIPTION OF THE DRAWINGS

The present invention can be appreciated by the description which follows in conjunction with the following figures, wherein:

FIG. 1 is a block diagram illustrating a configuration of a speech translation device according to a first embodiment of this invention;

FIG. 2 is an explanatory diagram illustrating relationships between processing carried out by respective components according to the first embodiment of this invention;

FIG. 3 is a flowchart illustrating an overall procedure of speech translation processing according to the first embodiment of this invention;

FIG. 4 is a block diagram illustrating a configuration of an input processing part according to the first embodiment of this invention;

FIG. 5 is a block diagram illustrating a configuration of a prosodic feature transform part according to the first embodiment of this invention;

FIG. 6 is an explanatory diagram illustrating an example of a configuration of a prosodic feature transform database according to the first embodiment of this invention;

FIG. 7 is a flowchart illustrating the procedure of processing carried out by the prosodic feature transform part according to the first embodiment of this invention;

FIG. 8 is an explanatory diagram describing an input part and an output part of the speech translation device according to a second embodiment of this invention; and

FIG. 9 is an explanatory diagram illustrating an example of an input/output screen of the speech translation device according to the second embodiment of this invention.

### DETAILED DESCRIPTION OF THE PREFERRED EMBODIMENTS

A description will now be given of embodiments of this invention with reference to drawings.

### First Embodiment

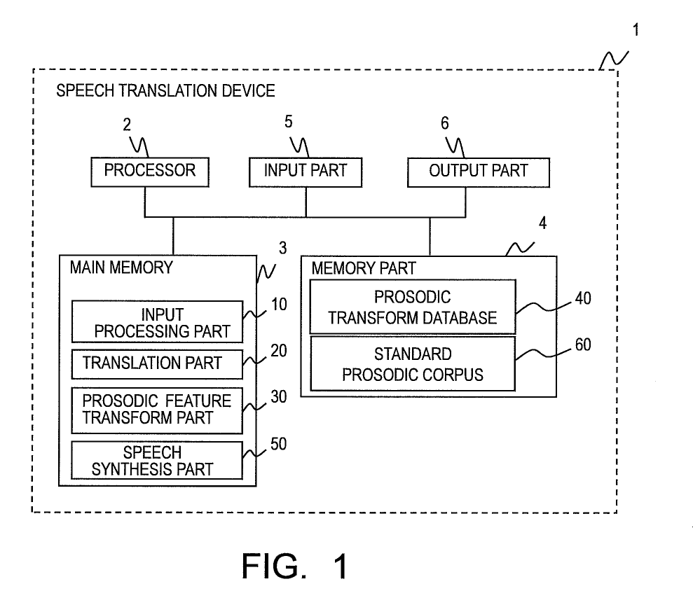

FIG. 1 is a block diagram illustrating a configuration of a speech translation device 1 according to a first embodiment of this invention.

The speech translation device 1 includes a processor 2, a main memory 3, a memory part 4, an input part 5, and an output part 6. According to the first embodiment, there is provided a configuration in which all functions are carried out by the speech translation device 1, but there may be provided a configuration in which, as a speech processing system, the respective functions are carried out by different computers, or a configuration in which an independent storage device may be added for storing data to be stored in the memory part 4.

The processor 2 carries out various types of processing by executing programs stored in the main memory 3.

The main memory 3 stores the programs executed by the processor 2, and data required for the execution of the various types of processing. The main memory 3 stores an input processing part 10, a translation part 20, a prosodic feature transform part 30, and a speech synthesis part 50. The input processing part 10, the translation part 20, the prosodic feature transform part 30, and the speech synthesis part 50 are programs executed by the processor 2.

The input processing part 10 processes an input speech in an original language. The translation part 20 translates (interprets) the input speech in the original language. It should be noted that the transforms carried out by the translation part 20 also include a transform within the same language such as a transform between dialects.

The prosodic feature transform part 30 analyzes the input speech in the original language, and extracts features of the prosodic thereof. Moreover, based on the extracted prosodic features and standard prosodic features of a target language, the prosodic feature transform part 30 transforms the prosody of the input speech in the original language into the prosody of the target language.

The speech synthesis part 50 synthesizes, based on the prosody of the target language obtained by the transform carried out by the prosodic feature transform part 30, a speech in the target language.

The memory part 4 stores programs and data necessary for speech translation processing according to this invention. The programs stored in the memory part 4 are loaded for execution to the main memory 3. Data stored in the memory part 4 includes a prosodic feature transform database 40 and a standard prosodic corpus 60.

The prosodic feature transform database 40 stores correspondence information between languages subject to translation. The standard prosodic corpus 60 is large text data including sentences in languages corresponding to the speech translation device 1 according to this invention. It should be noted that, for the sake of description of this invention, the standard prosodic corpus 60 of the original language (input) is an original language standard prosodic corpus 340 and the standard prosodic corpus 60 of the target language (output) is a target language standard prosodic corpus 350.

The input part 5 receives inputs such as speech information and text information. Specifically, the input part 5 includes a microphone for receiving an input of a speech, and a keyboard for receiving an input of text information.

The output part 6 outputs speech information and text information. Specifically, the output part 6 includes a speaker for outputting speech information, and a general-purpose display for displaying a result of the translation.

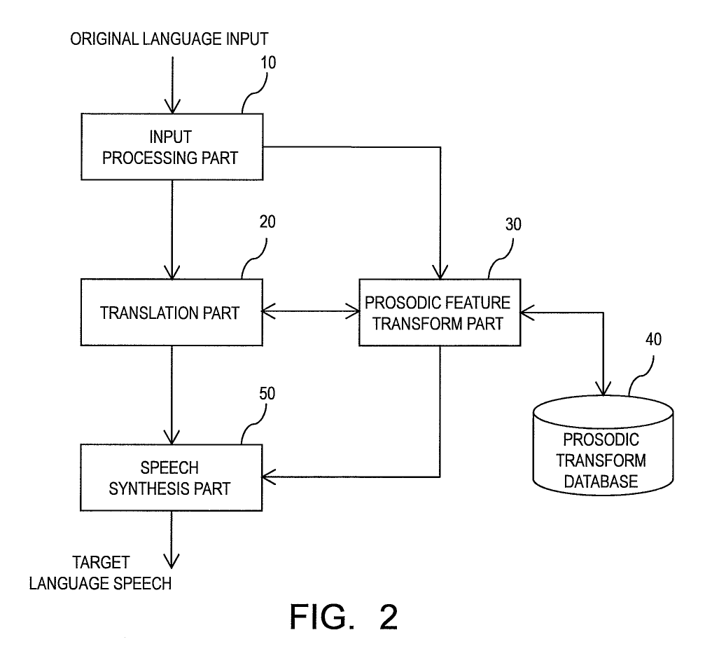

FIG. 2 is an explanatory diagram illustrating relationships between the processing carried out by respective components according to the first embodiment of this invention.

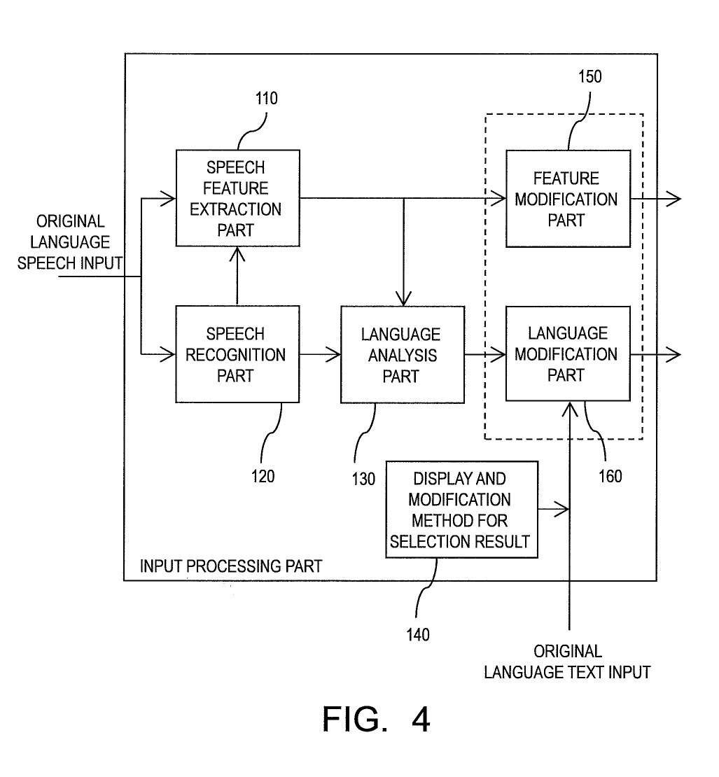

In the speech translation device 1 according to this invention, original speech data of the input language (first language) is received by the input processing part 10. The input processing part 10 transforms the input original speech data into a text, and passes the result of the transform to the translation part 20 and the prosodic feature transform part 30. The configuration of the input processing part 10 will later be detailed referring to FIG. 4.

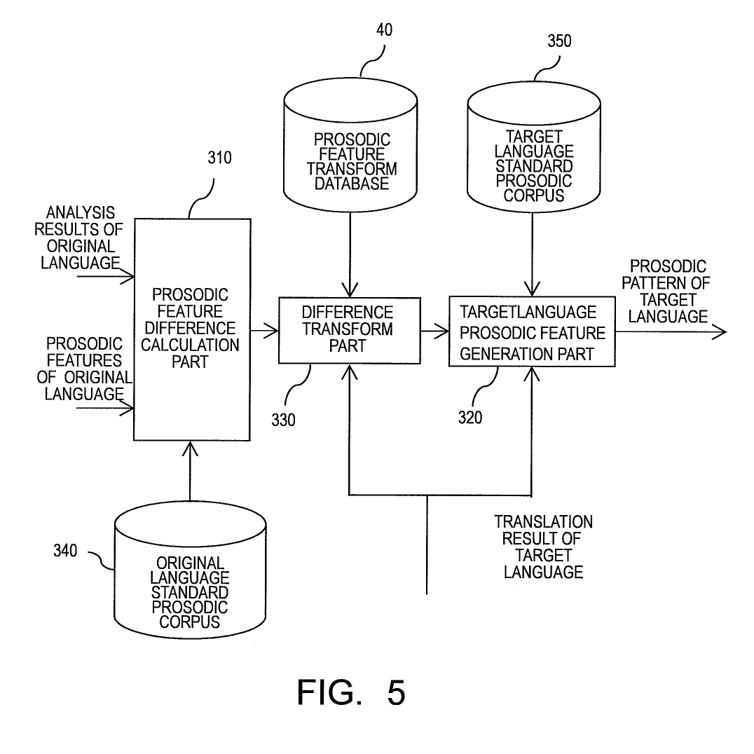

The translation part 20 translates the text transformed from the original speech data to a text in the target language (second language). The prosodic feature transform part 30, based on the data stored in the prosodic feature transform database 40, analyzes a prosodic feature pattern of the speech data in the input language, and generates a prosodic feature pattern of the speech data in the target language. The configuration of the prosodic feature transform part 30 will later be detailed referring to FIG. 5. A prosody is represented by how lengths of sounds, vowels/consonants, and accents are arranged, and a prosodic feature pattern is extracted features of a prosody.

The speech synthesis part 50 synthesizes a speech in the target language, based on the result of the translation carried out by the translation part 20, and the prosodic feature pattern generated by the prosodic feature transform part 30. Then, the speech synthesis part 50 outputs the synthesized speech in the target language from the output part 6.

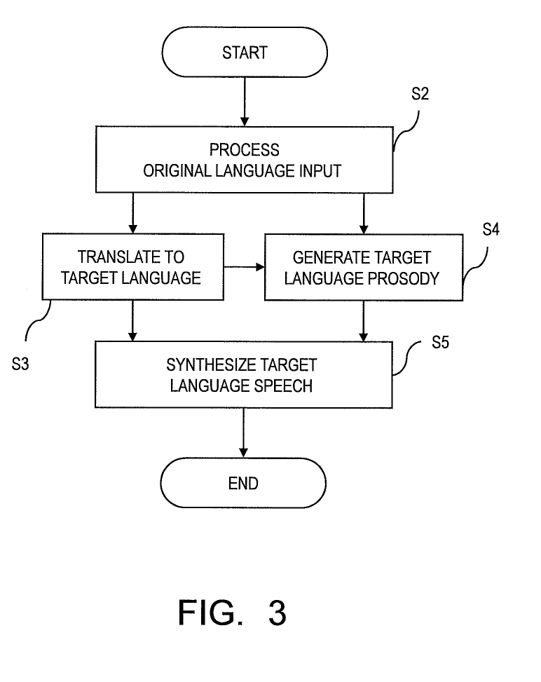

FIG. 3 is a flowchart illustrating an overall procedure of the speech translation processing according to the first embodiment of this invention.

In the speech translation processing according to the first embodiment of this invention, first, the processor 2 of the speech translation device 1 executes the input processing part 10 to carry out original language speech input processing (S2). In the original language speech input processing, the speech in the original language input from the input part 5 is received, and the speech in the original language is converted into a form suitable for the analysis. Specifically, the speech information is transformed into the text, and the prosodic information is extracted from the speech information.

When the original language speech input processing is finished, the processor 2 executes target language translation processing by executing the translation part 20 (S3). In the target language translation processing, the original language speech information, which has been converted into the text, is translated to the speech in the target language. As the technology for translating from the original language to the target language, an existing technology is employed.

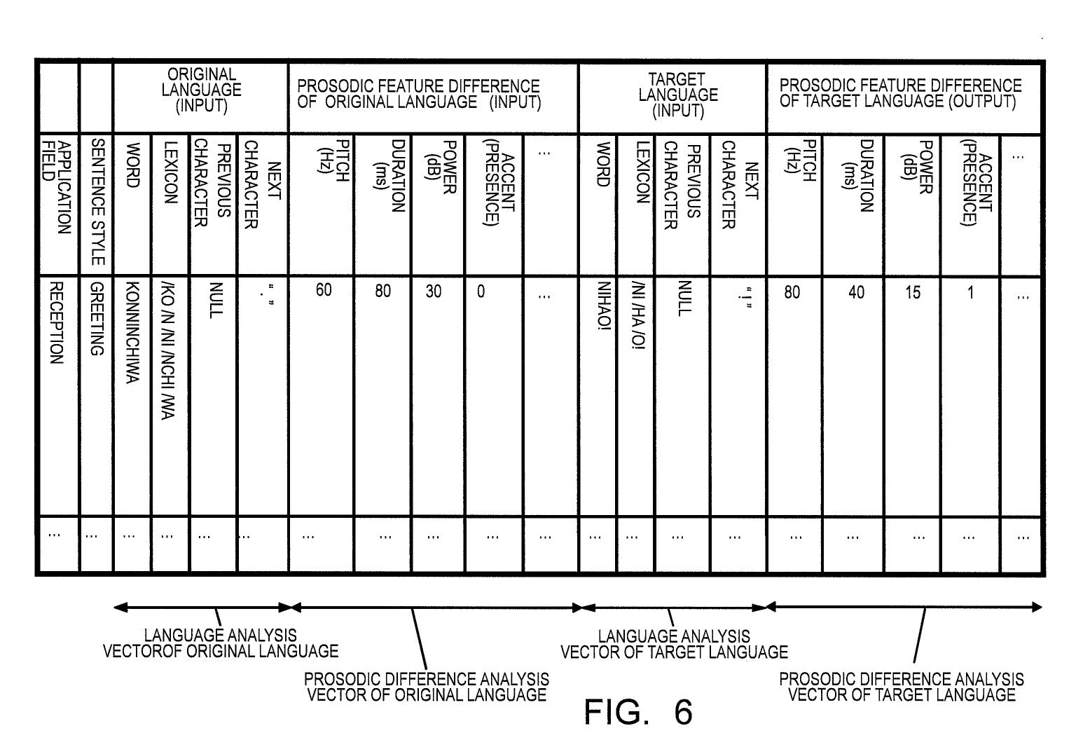

When the original language speech input processing and the target language translation processing is finished, the processor 2 executes target language prosody generation processing by executing the prosodic feature transform part 30 (S4). In the target language prosody generation processing, first, based on the prosodic information of the speech data in the input language extracted by the original language input processing, the prosodic feature pattern is analyzed. Then, based on the analyzed prosodic feature pattern and the result of the translation to the target language carried out by the target language translation processing, the prosodic information of the speech information of the target language is generated. The target language prosody generation processing will later be detailed referring to FIG. 6.

Finally, the processor 2, by executing the speech synthesis part 50, synthesizes a speech of the text translated into the target language (S5). Specifically, the processor 2 transforms the result of the translation to the target language obtained by the target language translation processing into the speech information, and synthesizes, based on the prosodic information generated by the target language prosody generation processing, the speech information.

FIG. 4 is a block diagram illustrating a configuration of the input processing part 10 according to the first embodiment of this invention.

The input processing part 10 has a configuration including a speech feature extraction part 110, a speech recognition part 120, a language analysis part 130, a display and modification means for the selection result 140, a feature modification part 150, and a language modification part 160.

When a speech in an original language is input, the input processing part 10 first acquires, by the speech recognition part 120, a language text in the original language and a result of recognition of phoneme segmentation. The phoneme segmentation is processing of dividing the input speech into respective phonemes.

Then, the input processing part 10 causes the speech feature extraction part 110, based on the input speech data in the original language and the result of recognition of phoneme segmentation acquired by the speech recognition part 120, to extract the prosodic feature pattern of the original language. The prosodic feature pattern includes specifically a pitch pattern, a power, an accent, a duration, and a length of silent section between phonemes.

Then, in the input processing part 10, the language analysis part 130 analyzes, based on the prosodic feature pattern of the original language extracted by the speech recognition part 120, the language text acquired by the speech recognition part 120. The analysis methods include the morphological analysis, the syntactic analysis, and the semantic analysis.

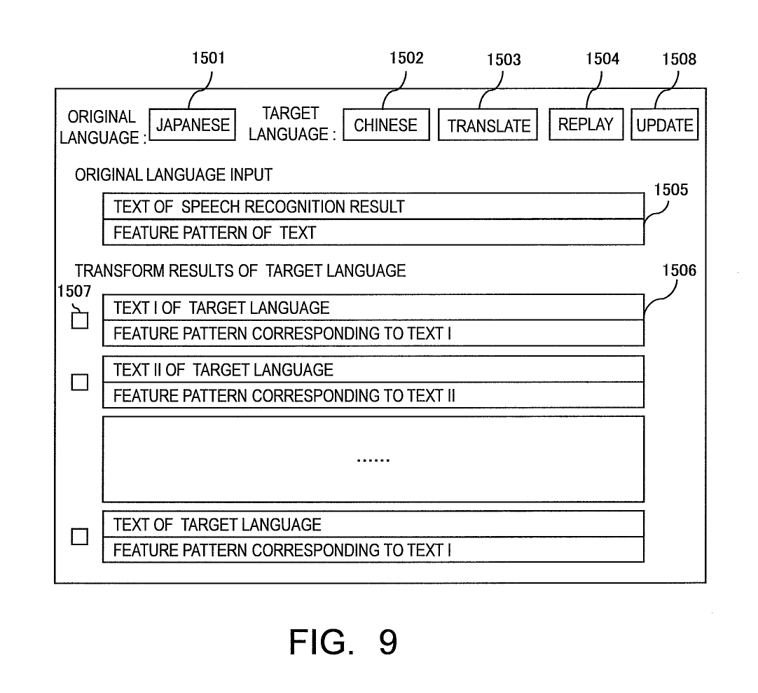

The input processing part 10 may cause the feature modification part 150 to modify the prosodic feature pattern of the original language extracted by the speech feature extraction part 110. Moreover, the input processing part 10 receives an input of text information in the original language, and may cause the language modification part 160 to modify the result of the analysis of the language text carried out by the language analysis part 130. The feature modification part 150 and the language modification part 160 receive an input from the display and modification means for the selection result 140 including an GUI, and modify the result of the analysis. An example of the GUI will later be described referring to FIG. 9.

The translation part 20 translates the information, as an input, including the language text in the original language and the result of the recognition of phoneme segmentation acquired by the input processing part 10 to the text in the target language. The translation processing carried out by the translation part 20 may employ any type of translation used for the machine translation system such as the general transfer translation, rule-based translation, statistical-language-model translation, and intermediate-language translation.

Moreover, the translation part 20 may determine, based on the prosodic feature pattern, portions emphasized in the sentence, thereby providing more suitable translation. For example, a description will now be given of a case for translation of an input sentence “the train bound for Tokyo will leave from Platform 3 at 9:40 soon” in Japanese as original language (first language) to a sentence in Chinese as a target language (second language). When “Platform 3” is emphasized in the input sentence, a word in Chinese corresponding to “Platform 3” is arranged at a position attracting the most attention in the translated sentence. Moreover, when “9:40” is focused in the input sentence, a corresponding Chinese word can be arranged at a position attracting the most attention in the translated sentence.

FIG. 5 is a block diagram illustrating a configuration of the prosodic feature transform part 30 according to the first embodiment of this invention.

The prosodic feature transform part 30 includes a prosodic feature difference calculation part 310, a difference transform part 330, and a target language prosodic feature generation part 320.

The prosodic feature difference calculation part 310 first receives the prosodic feature pattern of the original language acquired by the speech feature extraction part 110 or the feature modification part 150 of the input processing part 10, and the result of the syntactic analysis of the original language acquired by the language analysis part 130 or the language modification part 160. The prosodic feature difference calculation part 310 refers to the original language standard prosodic corpus 340, thereby calculating a difference between the prosodic feature pattern of the original language and a standard prosodic pattern. Specifically, the prosodic feature difference calculation part 310 compares the prosodic feature pattern of the original language and the standard prosodic pattern in terms of the pitch pattern, the power, the accent, the duration, the length of silent section between phonemes, or a prosodic feature pattern at a level of the entire input sentence.

Then, the difference transform part 330 receives inputs of the result of the translation carried out by the translation part 20 to the target language, and the result of the prosodic feature difference calculation of the original language. Then, the difference transform part 330, based on the prosodic feature transform database 40, acquires the most suitable prosodic feature pattern of the target language. The prosodic feature transform database 40 may be realized as, for example, a translation table based on corpuses, which will later be described referring to FIG. 6.

FIG. 6 is an explanatory diagram illustrating an example of a configuration of the prosodic feature transform database 40 according to the first embodiment of this invention.

In the prosodic feature transform database 40, a language analysis vector of original language, a prosodic difference analysis vector of original language, and a language analysis vector of target language are considered as retrieving conditions (input items), and a prosodic difference analysis vector of target language is considered as a retrieved result (output item). The prosodic difference analysis vector is a vector having elements acquired by representing the respective items constituting the prosodic feature pattern as numeric values.

Specifically, the retrieving conditions (input items) include an application field, a sentence style, a word, a lexicon, and previous/next characters of the original language, the prosodic difference analysis vector, a word, a lexicon, and previous/next characters of the target language. On the other hand, the retrieved result (output item) is the prosodic difference analysis vector of target language which is a destination of mapping. The prosodic difference analysis vector includes information such as the pitch pattern, the power, the accent, the duration, and the length of silent section between phonemes, and the prosodic feature pattern at a level of the entire input sentence (such as average pitch and average power).

In this way, the prosodic feature transform database 40 stores the language analysis vector and the prosodic difference analysis vector of original language, and the language analysis vector and the prosodic difference analysis vector of target language associated with each other. Thus, it is possible to obtain the prosodic of the target language to be output considering the prosodic of the original speech data. It should be noted that, in respective records of the prosodic feature transform database 40, a word of the original language and a word of the target language are not necessarily associated with each other one to one, and words may be associated with each other in a one-to-many manner.

Referring to FIG. 5 again, the difference transform part 330 acquires the prosodic difference analysis vector of target language which most matches the retrieving conditions from the prosodic feature transform database 40 according to an algorithm such as the maximum likelihood decision. A method for obtaining the prosodic difference analysis vector of the target language which most matches the retrieving conditions will be described later.

Then, the target language prosodic feature generation part 320 receives the prosodic difference analysis vector of target language and the result of the translation carried out by the translation part 20 to the target language as inputs, refers to the target language standard prosodic corpus 350, and generates the prosodic feature pattern of the target language.

A description will now be given of a procedure for transforming the prosodic of the input original language to the prosodic of the target language.

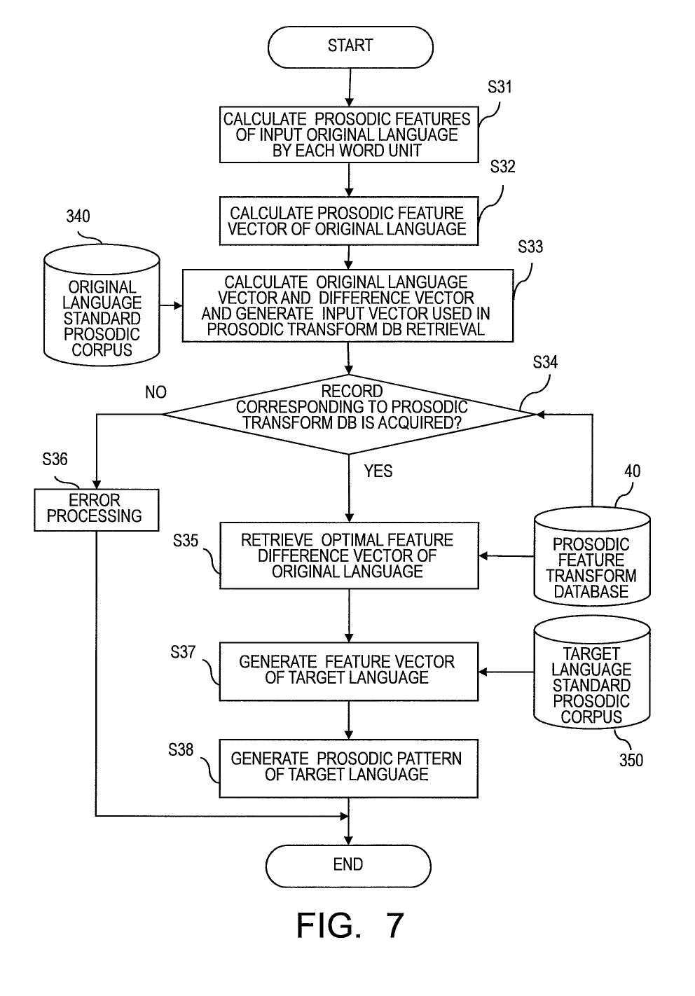

FIG. 7 is a flowchart illustrating the procedure of the processing carried out by the prosodic feature transform part 30 according to the first embodiment of this invention. This processing is carried out by the processor 2 of the speech translation device 1 executing the prosodic feature transform part 30.

The processor 2 first calculates, based on the prosodic feature pattern of the original language and the result of the syntactic analysis of the original language, prosodic features corresponding to respective words of the input sentence (S31). Then, the processor 2 calculates prosodic feature vectors corresponding to the respective words (S32).

The processor 2 calculates prosodic feature difference vectors between the prosodic feature vectors corresponding to the respective words and feature vectors corresponding to the respective words contained in the original language standard prosodic corpus 340 (S33). Further, the processor 2 produces, based on results of the translation to the target language corresponding to the respective words in the original language and the prosodic feature difference vectors of the original language, retrieving conditions for the prosodic feature transform database 40.

Then, the processor 2 retrieves records from the prosodic feature transform database 40, and determines whether records which match in terms of the respective language analysis vectors of the words of the original language and the result of the translation to the target language (refer to FIG. 6) have been acquired (S34). In the case of which the processor 2 has not retrieved matching records (“NO” in S34), the processor 2 carries out error processing (S36), and finishes the translation operation.

On the other hand, in the case of which the process 2 has retrieved records including matching language analysis vector portions (“YES in S34”), the processor 2 carries out processing for the records retrieved in prosodic feature transform database 40 in S35. On this occasion, in the case of which a Euclidean distance between the prosodic difference vector of original language acquired in the processing of S33 and a candidate prosodic difference vector of original language created in advance is the minimum, this distance is defined as the minimum vector distance. In the processing of S35, the processor 2 retrieves a prosodic feature difference vector of original language providing the minimum vector distance, namely, the optimal prosodic feature difference vector of original language. A prosodic feature difference vector of target language corresponding to the minimum vector distance of the prosodic difference vector of original language acquired in the processing of S35 is selected as the optimal prosodic difference vector of target language.

Then, the processor 2 calculates, based on the selected prosodic difference vector of target language and the standard feature vector of target language included in the target language standard prosodic corpus 350, a prosodic feature vector of the target language (S37). Finally, based on the generated prosodic feature vector, the processor 2 causes the target language prosodic feature generation part 320 to generate the prosodic feature pattern of the target language (S38).

More specifically, when the original language is Japanese, and the target language is English, a difference between a pitch pattern of an input Japanese original speech and a standard pattern is calculated. Based on the calculated difference, it is possible to estimate a proper stress pattern for a translation result in English obtained by the translation part 20.

Moreover, as another example, when the original language is Japanese, and the target language is Chinese, a difference between an overall pitch pattern feature reflected to a prosodic feature of an input Japanese interrogative sentence and a standard pattern is calculated. Based on the calculated difference, it is possible to generate a proper pitch pattern for a corresponding Chinese interrogative sentence.

The speech synthesis part 50 receives a string translated into the target language, synthesizes, based on the prosodic features of the transformed target language, speech, and outputs the synthesized speech from the output part 6. For the speech synthesis processing, conventional technologies are used, and therefore a detailed description thereof is omitted.

According to the first embodiment of this invention, based on the prosodic feature pattern of the input original language, by generating the prosodic feature pattern of the target language to be output and synthesizing the speech information to be output, it is possible to realize the speech translation output in a more natural utterance. For example, it is possible to synthesize an output speech having voice qualities similar to the input speech information. Further, according to the accent or the voice volume of the input speech, or based on a word to be emphasized, it is possible to handle a difference in nuance.

### Second Embodiment

While, according to the first embodiment of this invention, an input speech is translated based on the prosodic feature transform database 40, which has been input in advance, according to a second embodiment of this invention, a description will be given of a case in which the prosodic feature transform database 40 has a learning function, which is provided by users adding and updating data.

It should be noted that, a description of components of the second embodiment of this invention in common with those of the first embodiment of this invention are appropriately omitted.

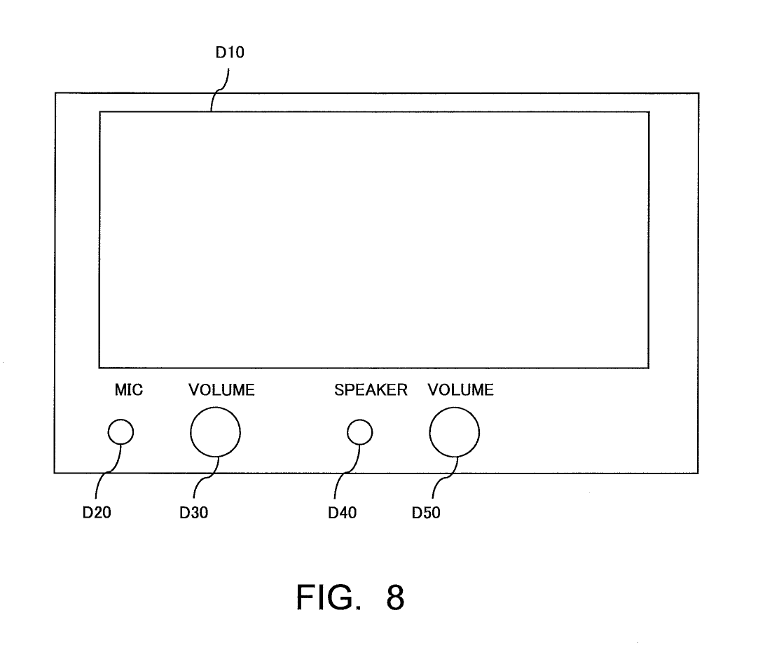

FIG. 8 is an explanatory diagram describing the input part 5 and the output part 6 of the speech translation device 1 according to the second embodiment of this invention.

The speech translation device 1 according to the second embodiment of this invention includes an input/output screen D10, an input part for microphone D20, a volume adjustment part for microphone D30, an output part for speaker D40, and a volume adjustment part for speaker D50.

The input/output screen D10 is constructed as a touch panel, and is a graphical user interface (GUI) for displaying records, and receiving changes to/addition of records in the prosodic feature transform database 40. The input/output screen D10 may serve as a GUI for inputting items to be modified to the feature modification part 150 and the language modification part 160 as described before according to the first embodiment.

In the speech translation device 1, a microphone is connected to the input part for microphone D20, and the volume adjustment part for microphone D30 is used to adjust the volume thereof. Moreover, a speaker is connected to the output part for speaker D40, and the volume adjustment part for speaker D50 is used to adjust the volume thereof.

FIG. 9 is an explanatory diagram illustrating an example of the input/output screen D10 of the speech translation device 1 according to the second embodiment of this invention.

The input/output screen D10 includes an original language type selection button 1501, a target language type selection button 1502, a translation button 1503, a replay button 1504, an original language input display part 1505, a target language transform result display part 1506, a target language transform result selection part 1507, and an update button 1508.

The original language type selection button 1501 is used to select the type of the original language of speech in the original language input from the input part for microphone D20 of the speech translation device 1. The target language type selection button 1502 is used to select a target language to which the original language is translated.

The translation button 1503 is used to execute the translation. The replay button 1504 is operated to again output the speech information.

The original language input display part 1505 displays a result of the processing by the input processing part 10 for the speech in the original language input from the input part for microphone D20 of the speech translation device 1. The original language input display part 1505 permits a change to a content output therefrom. By changing the content of the display being carried out by the original language input display part 1505, and operating the translation button 1503, the result of the language analysis and the prosodic feature pattern of the speech in the original language can be translated into a speech in the target language by the translation part 20 and the prosodic feature transform part 30.

Moreover, the target language transform result display part 1506 displays, as a result of the processing carried out by the translation part 20 and the prosodic feature transform part 30, the prosodic feature pattern corresponding to the result of the translation to the target language. Moreover, the target language transform result display part 1506 can display multiple results of the transform to the target language. A user can select the best result of the transform to the target language, and operates the corresponding target language transform result selection part 1507 to reflect the selected prosodic feature pattern to the output result. When the translation button 1503 is operated, based on the selected result of the transform to the target language, speech in the target language is synthesized by the speech synthesis part 50, and the synthesized speech is output from the output part for speaker D40. Moreover, the contents themselves displayed on the target language transform result display part 1506 may be changed.

Further, by operating the update button 1508, it is possible to update, based on changed contents on the original language input display part 1505 and/or the target language transform result display part 1506, the prosodic feature transform database 40.

According to the second embodiment of this invention, it is possible to cause, by modifying the results of the processing carried out by the input processing part 10 and the results of the processing carried out by the prosodic feature transform part 30, the prosodic feature transform database 40 to learn the modifications, thereby increasing the accuracy of the translation.

While the present invention has been described in detail and pictorially in the accompanying drawings, the present invention is not limited to such detail but covers various obvious modifications and equivalent arrangements, which fall within the purview of the appended claims.

What is claimed is:

1. A speech processing system for receiving an input of an original speech in a first language, transforming a content of the input into a second language, and outputting a result of the transforming as a speech, comprising:
an input processing part for receiving the input of the original speech, and generating, from the original speech, an original language text, which is a text in the first language, and prosodic information of the original speech;
a translation part for generating a translated sentence which is obtained by transforming the original language text from the first language into the second language;
prosodic feature transform information including a correspondence relationship between prosodic information of the first language and prosodic information of the second language;
a prosodic feature transform part for transforming, based on the prosodic feature transform information, prosodic information of the original speech into prosodic information of the speech to be output; and
a speech synthesis part for outputting the translated sentence as a speech synthesized based on the prosodic information of the speech to be output.

2. The speech processing system according to claim 1, wherein:
the speech processing system stores first standard prosodic information including standard prosodic information of the first language and second standard prosodic information including standard prosodic information of the second language; and
the prosodic feature transform part is configured to:
acquire, based on the first standard prosodic information, difference information between the prosodic information of the original speech and the standard prosodic information of the first language;
retrieve, based on the translated sentence and the difference information of the prosodic information of the original speech, the prosodic information of the second language from the prosodic feature transform information;
acquire, based on the second standard prosodic information, difference information between the retrieved prosodic information of the second language and the standard prosodic information of the second language; and
generate, based on the difference information of the retrieved prosodic information of the second language, the prosodic information of the speech to be output.

3. The speech processing system according to claim 2, wherein the prosodic feature transform part is further configured to generate the prosodic information of the speech to be output by dividing the original language text into words, and acquiring the difference information of the prosodic information of the second language for each of the divided words.

4. The speech processing system according to claim 2, wherein:
the prosodic information is represented by a vector having each of items including a pitch and an accent as a numeric value; and
the prosodic feature transform part, in the case of retrieving the prosodic information of the second language corresponding to the prosodic information of the first language from the prosodic feature transform information, is further configured to acquire, as a result of the retrieving, the prosodic information of the second language, which provides a minimum Euclidean distance between a vector representing the prosodic information of the original speech and a vector representing the prosodic information of the first language.

5. The speech processing system according to claim 1, wherein the input processing part is configured to:
analyze a phoneme included in the original speech;
generate the prosodic information of the original speech based on a result of the analyzing the phoneme; and
generate the original language text based on the prosodic information of the original speech.

6. The speech processing system according to claim 1, wherein the prosodic feature transform part is configured to:
display a result of the transforming, which comprises the translated sentence and the prosodic information corresponding thereto;
receive the corrected result of the transforming; and
update, based on the corrected result of the transforming, the prosodic feature transform information.

7. A machine-readable medium, containing at least one sequence of instruction for controlling a speech processing device to receive an input of an original speech in a first language, transform a content of the input into a second language, and output a result of the transforming as a speech,
the speech processing system, which includes the speech processing device, comprising prosodic feature transform information including a correspondence relationship between prosodic information of the first language and prosodic information of the second language,
the sequence of instructions causing the speech processing device to:
receive an input of the original speech;
generate, from the original speech, an original language text, which is a text in the first language, and prosodic information of the original speech;
generate a translated sentence which is obtained by transforming the original language text from the first language into the second language;
transform, based on the prosodic feature transform information, the prosodic information of the original speech into prosodic information of the speech to be output; and
output the translated sentence as a speech synthesized based on the prosodic information of the speech to be output.

8. The machine-readable medium according to claim 7, wherein:
the speech processing system stores first standard prosodic information including standard prosodic information of the first language and second standard prosodic information including standard prosodic information of the second language; and
the step of transforming the prosodic information includes sequence of instructions of:
acquiring, based on the first standard prosodic information, difference information between the prosodic information of the original speech and the standard prosodic information of the first language;
retrieving, based on the translated sentence and the difference information of the prosodic information of the original speech, the prosodic information of the second language from the prosodic feature transform information;
acquiring, based on the second standard prosodic information, difference information between the retrieved prosodic information of the second language and the standard prosodic information of the second language; and
generating, based on the difference information of the retrieved prosodic information of the second language, the prosodic information of the speech to be output.

9. The machine-readable medium according to claim 8, wherein the step of transforming the prosodic information further includes sequence of instructions of:
dividing the original language text into words; and
generating the prosodic information of the speech to be output by acquiring the difference information of the prosodic information of the second language for each of the divided words.

10. The machine-readable medium according to claim 8, wherein:
the prosodic information is represented by a vector having each of items including a pitch and an accent as a numeric value; and
the step of retrieving the prosodic information from the prosodic feature transform information includes instruction of acquiring, as a result of the retrieving, the prosodic information of the second language, which provides a minimum Euclidean distance between a vector representing the prosodic information of the original speech and a vector representing the prosodic information of the first language.

11. The machine-readable medium according to claim 7, wherein the step of generating the original language text and the prosodic information of the original speech includes sequence of instructions of:
analyzing a phoneme included in the original speech;
generating the prosodic information of the original speech based on a result of the analyzing the phoneme; and
generating the original language text based on the prosodic information of the original speech.

12. The machine-readable medium according to claim 7, wherein the step of transforming the prosodic information includes sequence of instructions of:
displaying a result of the transforming, which comprises the translated sentence and the prosodic information corresponding thereto;
receiving a correction of the result of the transforming; and
updating, based on the corrected result of the transforming, the prosodic feature transform information.

13. A speech processing method used in a speech processing system for receiving an input of an original speech in a first language, transforming a content of the input into a second language, and outputting a result of the transforming as a speech,
the speech processing system comprising prosodic feature transform information including a correspondence relationship between prosodic information of the first language and prosodic information of the second language,
the speech processing method comprising the steps of:
receiving the input of the original speech;
generating, from the original speech, an original language text, which is a text in the first language, and prosodic information of the original speech;
generating a translated sentence which is obtained by transforming the original language text from the first language into the second language;
transforming, based on the prosodic feature transform information, the prosodic information of the original speech into prosodic information of the speech to be output; and
outputting the translated sentence as a speech synthesized based on the prosodic information of the speech to be output.
